(19) United States
(12) Patent Application Publication
(10) Pub. No.: US 2015/0378881 A1
(43) Pub. Date: Dec. 31, 2015

(54) PLATFORM-INDEPENDENT SELENIUM TO APPLICATION LIFECYCLE MANAGEMENT ("ALM") SERVER CONNECTIVITY

(71) Applicant: Bank of America Corporation, Charlotte, NC (US)

(72) Inventors: Madhav Vaidyanath, Tamil Nadu (IN); Venkata Sai Kuthsav Thattai, Andhra Pradesh (IN); Kishore Kumar Sankaranarayanan, Tamil Nadu (IN)

(21) Appl. No.: 14/318,912

(22) Filed: Jun. 30, 2014

(51) Int. Cl. G06F 11/36; H04L 29/08

(52) U.S. Cl. CPC G06F 11/3696; H04L 67/02; G06F 11/3688

(57) ABSTRACT

A method for providing a platform-independent wrapper for an application lifecycle management representational state of transfer server application programming interface (“ALM REST API”), The method may include using a receiver to receive defects from a test automation tool and using a processor to marshal the defects into XML objects. The method may further include using a transmitter to transmit the XML objects to the ALM REST API and using the receiver to receive XML test scripts from the ALM REST API. In addition, the method may include using the processor to unmarshal the test scripts into JAVA objects and using the transmitter to transmit the JAVA objects to the test automation tool.

### FIELD OF TECHNOLOGY

The disclosure relates to application programming interfaces (“APIs”) for use with Selenium, or other similar automated testing tools (referred to collectively herein as “Selenium”).

### BACKGROUND OF THE DISCLOSURE

Selenium is an open source automated testing suite for web applications. Selenium may be implemented across different browsers and/or platforms. Selenium focuses on automating testing of web-based applications.

Selenium has certain advantages over other testing suites. For example, Selenium supports multi-threading/parallel execution and hence faster execution. Selenium also enables early engagement of test teams as part of the development cycle. Accordingly, Selenium promotes earlier detection of defects, faster execution of regression and, therefore, better user experiences.

As stated above, Selenium supports multiple browsers. These browsers include Internet Explorer™, Firefox™, Safari™, Opera on Windows™, Mac OS X™ and/or Linux™. Selenium also supports Wires Object Oriented Programming languages like JAVA, .NET, Ruby, Perl, PHP, etc.

It would be desirable to provide an API wrapper for connection to automated testing tools such as Selenium that is platform-independent and, therefore, may be used with various different platforms.

### SUMMARY OF THE DISCLOSURE

Certain embodiments of the invention may include a platform-agnostic wrapper for an application lifecycle management representational state of transfer server application programming interface (“ALM REST API”). The wrapper may include a receiver configured to receive defects (and/or other suitable ALM entities) from a test automation tool. For the purposes of this application the term defect may be understood to include any problems with the login to a web page, any issues with the links associated with the web page, anything that is not working on a web page as it should or is not working as expected.

The wrapper may also include a processor configured to marshal the defects (and/or other suitable ALM entities) into XML objects and a transmitter configured to transmit the XML objects to the ALM REST API.

The receiver may be further configured to receive XML test scripts from the ALM REST API. The processor may be further configured to unmarshal the test scripts into JAVA objects. The transmitter may be further configured to transmit the JAVA objects to the test automation tool.

The processor may be further configured to receive defects (and/or other suitable ALM entities) from a test automation tool and marshal the defects (and/or other suitable ALM entities) into XML objects by marshalling the defects (and/or other suitable ALM entities) into XML objects using JAVA architecture for XML binding (“JAXB”).

The processor may be further configured to receive XML test scripts from the ALM REST API and unmarshal the test scripts into JAVA objects using JAVA architecture for XML binding (“JAXB”).

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIG. 3 shows an illustrative schematic of a system; and

FIG. 4 shows an illustrative schematic of a system for use with certain embodiments of the system.

### DETAILED DESCRIPTION OF THE DISCLOSURE

Systems and methods for providing APIs for use with Selenium, or other such automated testing tools, are set forth herein.

APIs are to software and/or hardware information systems as plug and socket designs are to appliances, such as lamps. More specifically, APIs allows software and/or hardware information systems to interoperate with other systems and/or programs, in a way similar to the way that plugs and sockets allow lamps to operate with the electrical grid. Just as a plug conforms to the contours of a socket in order for electricity to flow to allow the lamp to operate, so to a computer program designed to be compatible with another program should preferably conform to the API of the first program. In other words, the API of the first program may establish rules about how other programs can send and receive information so that the two programs can work together to execute specific tasks.

Once the API for the first program exists, it becomes a constraint on the design of follow-on programs that are developed to work with the first program.

Systems, methods and/or platforms according to certain embodiments may provide a wrapper for the application lifecycle management representational state of transfer (an option for developing web services) server application programming interface (“ALM REST API”). The wrapper, according to some embodiments, acts as an interface between a JAVA-language based test automation tool and an ALM/Quality Center (“QC”) server (hereinafter, “the ALM server”). One objective of the embodiments is to provide a preferably fully functional JAVA-based API to interface with the functions supported by ALM REST API. Such a JAVA-based API preferably enables a user to use REST rather than writing OTA code. Accordingly, a user can now accomplish some of the same functionality also using a test automation tool UI instead of writing code.

Some of the ALM entities that may be accessed using the wrapper according to the invention may include ALM defects (and/or other suitable ALM entities), resources, requirements, tests and/or test labs.

The absence of a proper JAVA API to interoperate with an ALM server presents difficulty for testers and/or programmers who use Selenium or other JAVA-based test automation tools.

While testers and/or programmers can use the API from the ALM directly using httpclient and/or httpcore libraries (sets of low level hyper-text transport protocol (“HTTP”) transport components that can he used to build custom client and server side HTTP), extra programming effort is typically needed to parse the XML response returned by the server. However, certain embodiments of the invention may preferably handle everything internally by using JAXB (JAVA architecture for XML binding) to convert XML to a JAVA object (commonly referred to as unmarshalling the XML), such as a JAVA bean, and vice versa—i.e., to convert a JAVA object to XML (commonly referred to as marshalling the object into XML).

The following exemplary case compares the use of one exemplary piece of code according to the invention as opposed to the previously-required code prior to the invention:

To better understand the improvements according to the present invention, the following considers an examplary obtaining of a Folders list under a particular folder in the Test-Plan from QC/ALM.

### Conventional Method (Using HttpClient and HttpCore Libraries)

| | |
|---|---|
| String urlx =“http://qc | .com/qcbin/rest/domains/<domain-name>/projects/<project-name>/test- |

folders?query={parent-id[<parent-id>]}&page-size=5000”;
try {

URL url = new URL(urlx);
String nullFragment = null;
uri2 = new URI(url.getProtocol( ), url.getHost( ),

url.getPath( ), url.getQuery( ), nullFragment);

System.out.println(“URI ” + uri2.toString( ) + “ is

OK”);

} catch (MalformedURLException e) {

System.out.println(“URL ” + url2 + “ is a malformed

URL”};

} catch (URISyntaxException e) {

System.out.println(“URI ” + url2 + “ is a

malformed(SYNTAX) URL”);

}

DocumentBuilderFactory factory;
DocumentBuilder builder = null;
Document doc = null;
TransformerFactory transformerFactory;
Transformer transformer = null;
DOMSource source;

Credentials credentials = new UsernamePasswordCredentials(“UserName”, “passWord”);

CredentialsProvider credsProvider = new BasicCredentialsProvider( );
credsProvider.setCredentials(

```
  new AuthScope(somehost, AuthScope.ANY_PORT),
  credentials);
```

CloseableHttpClient httpclient = HttpClients.custome( )

.setDefaultCredentialsProvider(credsProvider)
.build( );

HttpGet httpGet = new HttpGet(“http://qc11.bankofamerica.com/qcbin/authentication-

point/authenticate”);

FileOutputStream fop = null;

File file;

try {

response = httpclient.execute(httpGet);
Header[ ] headers = response.getAllHeaders( );
for (Header header : headers) {

if(header.getName( ).contentEquals(“Set-Cookie”)){
System.out.println(“Getting Headers...”);
primaryCookieKey = header.getName( );
primaryCookieValue = header.getValue( ):
System.out.println(primaryCookieKey);
System.out.println(primaryCookieValue);
}

}

System.out.println(response.getStatusLine( ).toString( ));

System.out.println(EntityUtils.toString(response.getEntity( )));

httpGet = new HttpGet(uri2);

httpGet.addHeader(primaryCookieKey, primaryCookieValue);
httpGet.addHeader(“Accept”, “application/xml”);

try {

response = httpclient.execute(httpGet);

System.out.println(response.getStatusLine( ).toString( ));

Header[ ] headers = response.getAllHeaders( );
for (Header header : headers) {

If(header.getName( ).contentEquals(“Set-

Cookie”)){

System.out.println(“Getting Headers...”);
qcSessionCookieKey = header.getName( );
qcSessionCookieValue = header.getValue( );
System.out.println(“QCsession key:

”+qcSessionCookieKey);

System.out.println(“QCsession value:

”+qcSessionCookieValue);

}

}

factory = DocumentBuilderFactory.newInstance( );

try {

builder = factory.newDocumentBuilder( );

} catch (ParserConfigurationException e1) {

// TODO Auto-generated catch block
e1.printStackTrace( );

}
try {

doc =

builder.parse(response.getEntity( ).getContent( ));

} catch (IllegalStateException e1) {

// TODO Auto-generated catch block
e1.printStackTrace( );

} catch (SAXException e1) {

// TODO Auto-generated catch block
e1.printStackTrace( );

}
//Write xml//
transformerFactory = TransformerFactory.newInstance( );
try {

transformer =

transformerFactory. newTransformer( );

} catch (TransformerConfigurationException e1) {

// TODO Auto-generated catch block
e1.printStackTrace( );

}
source = new DOMSource(doc);
StreamResult result = new StreamResult(new

File(“C:\\Users\\zk0iov3\\Documents\\kuthsav\\Quality Center-Coding and Other
Codes\\folders.xml”));

// Output to console for testing
// StreamResult result = new StreamResult(System.out);
try {

transformer.transform(source, result);

} catch (TransformerException e1) {

// TODO Auto-generated catch block
e1.printStackTrace( );

}

} catch (ClientProtocolException e) {

// TODO Auto-generated catch block
e.printStackTrace( );

} catch (IOException e) {

// TODO Auto-generated catch block
e.printStackTrace( );

}

Furthermore, the file saved should be parsed by any logic to get the required information from the XML document. This requires extra programming resources.

Using Java-Quality Center (“QC”—an alternative reference to the ALM server) Connectivity according to the invention:

| | |
|---|---|
| QCConnect qc = new QCConnect(“http://qc | .com”, QCUsername, QCpassword); |

qc.qcAuthenicate( );
qc.setDomain(<domain-name>);
qc.setProject(<project-name>);
qc.setUrlPath( );
try {

List<QCEntity> testPlanFolders = qc.getChildTestPlanFolders(<parent-

id>);

} catch (Exception e) {
}

In the embodiments according to the invention, the list of type QCEntity testPlanFolders can be simply iterated to get the required information. This preferably reduces programming resources required to implement the obtaining of the folders.

While the ALM server may also be connected with via OTACLIENT.DLL, which is a corn-object bridge, such as a com-JAVA bridge like com4J, nevertheless, these additional layers typically introduce compatibility issues, whereas embodiments according to the invention do not use any com objects and can be used with JAVA on a variety of platforms—i.e., the embodiments according to the invention are preferably platform-agnostic and thereby independent of the underlying platform.

Certain embodiments may cover the following ALM server functionalities: authentication, session management, collecting domains and projects that a user is allowed to access, list collection, getting release-cycles and releases, mandatory fields collection for entity (defect, test, test-instance, test-folder, test-set-folder, test-set) creation, uploading and downloading images and/or attachment to/from defects (and/or other suitable ALM entities), creating new test entities (test folder, test-set folder) and/or adding the scripts/other files to the created test entities getting attachment list associated with entities (test, test-folder, defect), creating test-instance and updating execution status of entities (test instances and test cases)

A method for providing a platform-independent wrapper for an application lifecycle management representational state of transfer server application programming interface (“ALM REST API”) is provided. The method may include using a receiver to receive defects (and/or other suitable ALM entities) from a test automation tool. The method may include using a processor to marshal the defects (and/or other suitable ALM entities) into XML objects. The method may further include using a transmitter to transmit the XML objects to the ALM REST API, using the receiver to receive XML test scripts from the ALM REST API, using the processor to unmarshal the test scripts into JAVA objects and using the transmitter to transmit the JAVA objects to the test automation tool.

The method may also include using a receiver to receive defects (and/or other suitable ALM entities) from a test automation tool and marshalling the defects (and/or other suitable ALM entities) into XML objects using JAVA architecture for XML binding (“JAXB”).

The method may also include using the receiver to receive XML test scripts from the ALM REST API and using the processor to unmarshal the test scripts into JAVA objects using JAVA architecture for XML binding (“JAXB”).

The method may also include operating the processor independently of a platform additional to the ALM REST API. The integration of the wrapper may be implemented independently of a platform additional to the ALM REST API. The wrapper may interoperate with the ALM REST API to run a JAVA environment independently of a com-bridge. The wrapper is preferably configured to operate to provide an interface for at least all of the group of operations consisting of authentication, session management, collecting domains and projects that a user can access, list collection, obtaining release-cycles and releases, mandatory fields collection for defect creation, uploading image attachment to defects (and/or other suitable ALM entities), mandatory fields collection for test creating, creating new test entities and adding the scripts/other files to the created test entity.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

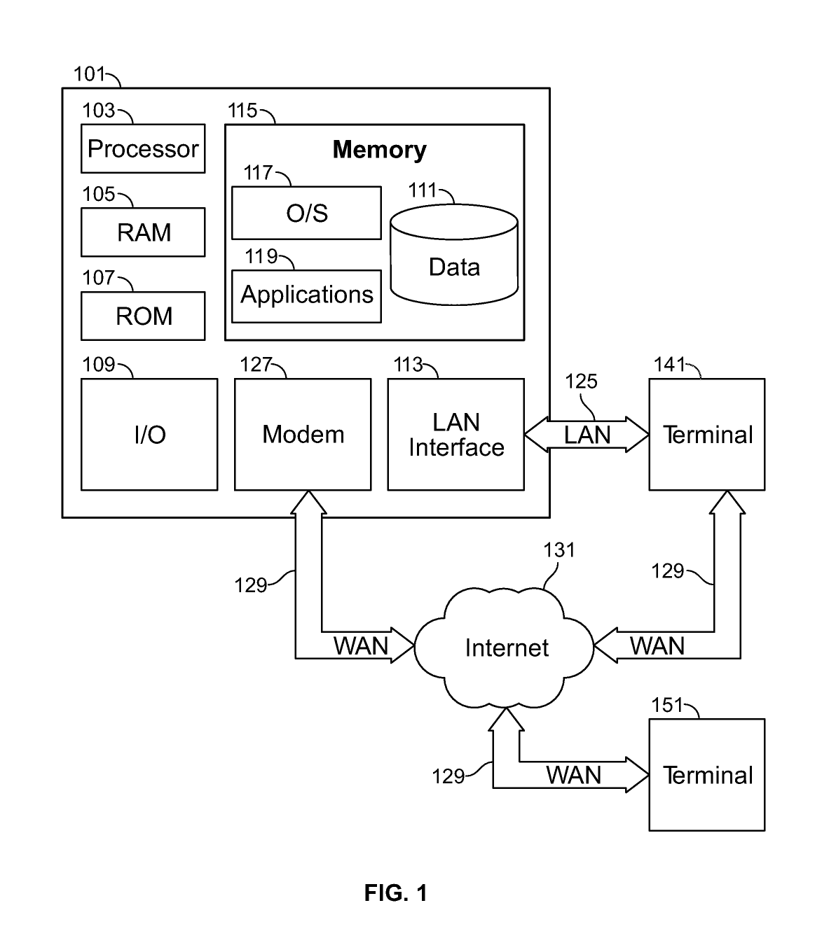

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for transferring information input into one or more of the database(s) described herein, as well as defect information, test script information, JAXB information, JAVA bean information, other JAVA object information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

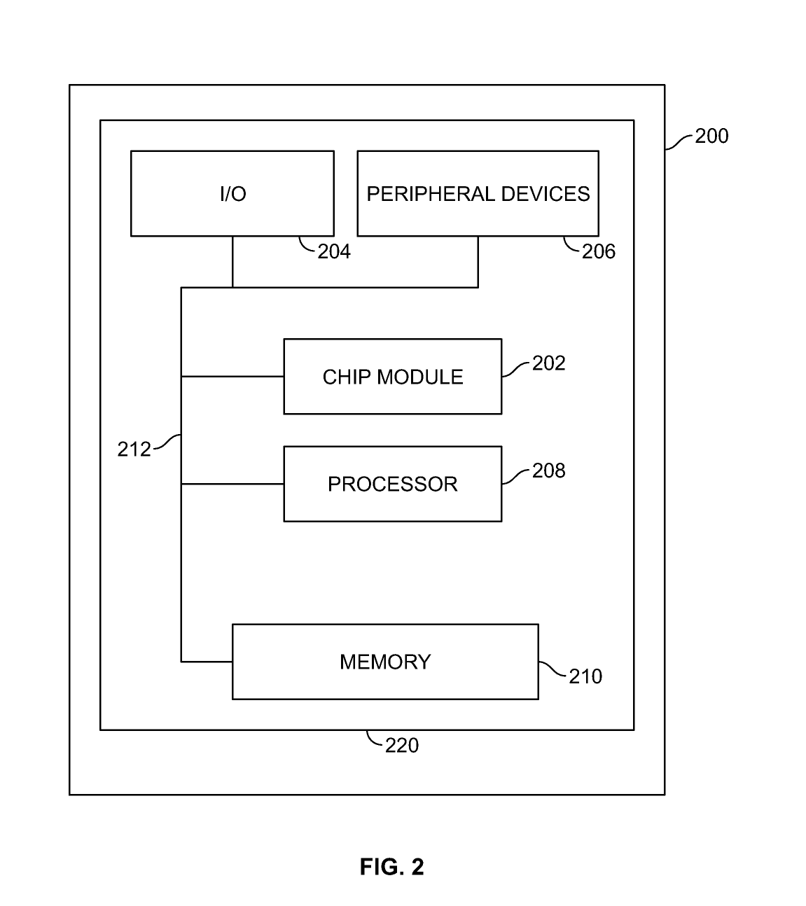

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indices; and machine-readable memory 210.

Machine-readable memory 210 may be configured to store in machine-readable data structures: CPG information, financial institution (“FI”) information, customer benefit offer information; customer information and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

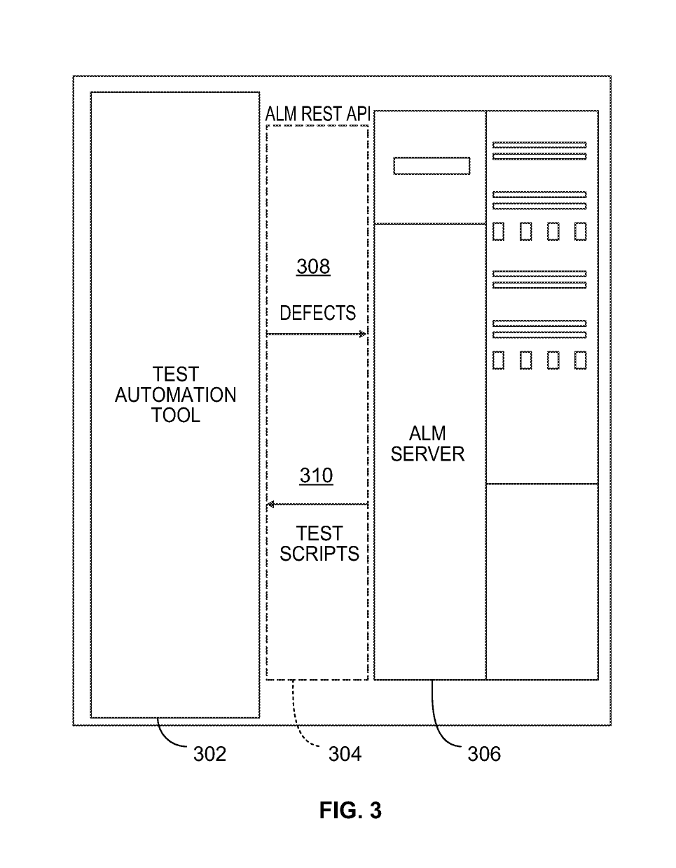

FIG. 3 shows an illustrative schematic of a conventional system. The system may include a JAVA-based test automation tool, such as Selenium or other suitable JAVA-based test automation. The system may also include an ALM REST API 304 and an ALM server.

The ALM REST API 304 may transfer the defects (and/or other suitable ALM entities) 308, and any other suitable ALM objects, to ALM server 306. The ALM REST API 304 may also transfer test scripts 310 from ALM server 306 to test automation tool 302. It should be noted that in the absence of conversion software from JAVA to XML, the transfer of information from ALM server 306 to test automation tool 302 presents difficulties to programmers. For example, programmers and testers who want to use Selenium and/or other JAVA-based testing tools are largely precluded from doing so because of the language barrier between JAVA-based tools and the ALM server.

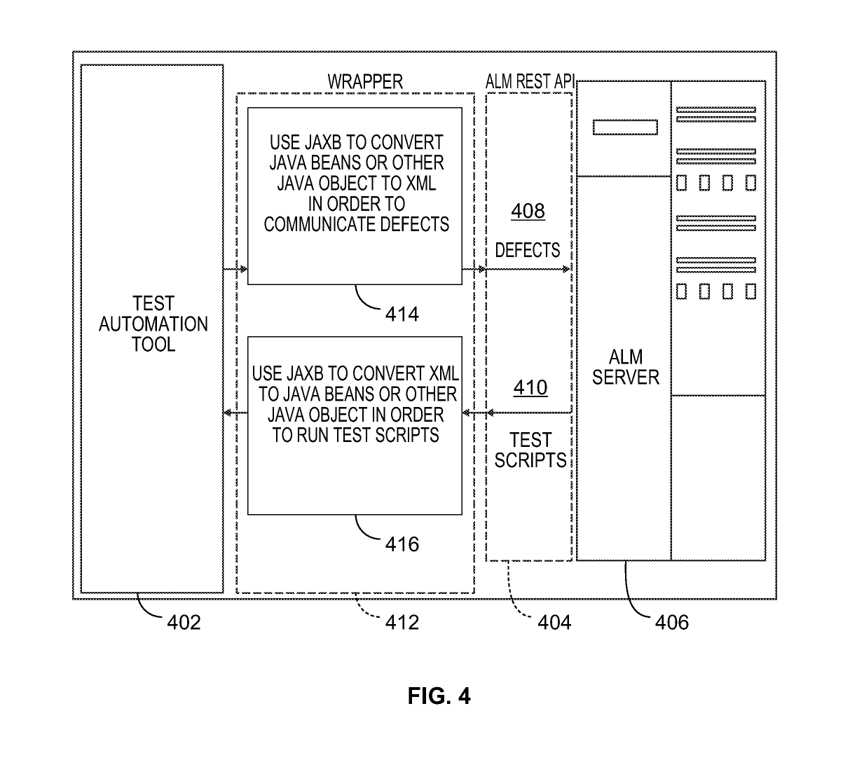

FIG. 4 shows an illustrative schematic of a system for use with certain embodiments of the system according to the invention. The system according to the invention may include test automation tool 402. The system may also include ALM Server 406. The system may also include ALM REST API 404 which may receive defects (and/or other suitable ALM entities) 408 and transmit them to ALM server 406 and receive test scripts 410 from ALM server 406 for further transmission.

FIG. 4 also shows wrapper 412, in one embodiment, using JAXB to convert JAVA beans or other JAVA objects to XML in order to communicate defects 414 (or other ALM objects) to the ALM REST API 404. As shown at 416, wrapper 412 may also use JAXB to convert test scripts 410 received from ALM REST API 404 to JAVA beans, or other suitable JAVA objects, and to transmit the JAVA beans to the test automation tool.

Thus, methods and apparatus for providing platform-independent selenium to ALM-server JAVA connectivity have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. A platform-agnostic wrapper for an application lifecycle management representational state of transfer server application programming interface (“ALM REST API”), the wrapper comprising:
a receiver configured to receive defects and/or other suitable ALM entities from a test automation tool;
a processor configured to marshal the defects and/or other suitable ALM entities into XML objects;
a transmitter configured to transmit the XML objects to the ALM REST API;
wherein the receiver is further configured to receive XML test scripts from the ALM REST API and the processor is further configured to unmarshal the test scripts into JAVA objects; and
wherein the transmitter is further configured to transmit the JAVA objects to the test automation tool.

2. The wrapper of claim 1, wherein the processor is further configured to marshal the defects and/or other suitable ALM entities into XML objects using JAVA architecture for XML binding (“JAXB”).

3. The wrapper of claim 1, wherein the processor is further configured to unmarshal the test scripts into JAVA objects using JAVA architecture for XML binding (“JAXB”).

4. The wrapper of claim 1, wherein the processor is configured to operate independently of a platform additional to the ALM REST API.

5. The wrapper of claim 1, wherein the integration of the wrapper is implemented independently of a platform additional to the ALM REST API.

6. The wrapper of claim 1, wherein the wrapper interoperates with the ALM REST API to run a JAVA environment independently of a com-bridge.

7. The wrapper of claim 1, wherein the wrapper is configured to operate to provide an interface for at least one of the group consisting of authentication, session management, collecting domains and projects that a user can access, list collection, obtaining release-cycles and releases, mandatory fields collection for entities creation, wherein said entities comprise at least one of defect, test, test-instance, test-folder, test-set-folder and test-set, uploading and downloading images and/or attachments to/from defects and/or other ALM entities, creating new test entities, and/or adding the scripts/other files to the created test entities, getting attachment list associated with entities, creating test-instance and updating execution statues of entities.

8. An article of manufacture comprising a non-transitory computer usable medium having computer readable program code embodied therein, the code when executed by one or more processors for configuring a computer to execute a method for providing a platform-independent wrapper for an application lifecycle management representational state of transfer server application programming interface (“ALM REST API”), the method comprising:
using a receiver to receive defects and/or other ALM entities from a test automation tool;
using a processor to marshal the defects and/or other ALM entities into XML objects;
using a transmitter to transmit the XML objects to the ALM REST API;
using the receiver to receive XML test scripts from the ALM REST API;
using the processor to unmarshal the test scripts into JAVA objects; and
using the transmitter to transmit the JAVA objects to the test automation tool.

9. The method of claim 8 further comprising marshalling the defects and/or other suitable ALM entities into XML objects using JAVA architecture for XML binding (“JAXB”).

10. The method of claim 8 further comprising unmarshalling the test scripts into JAVA objects using JAVA architecture for XML binding (“JAXB”).

11. The method of claim 8, further comprising operating the processor independently of a platform additional to the ALM REST API.

12. The wrapper of claim 8, wherein the processor is configured to operate independently of a platform additional to the ALM REST API.

13. The wrapper of claim 8, wherein the integration of the wrapper implemented independently of a platform additional to the ALM REST API.

14. The wrapper of claim 8, wherein the wrapper interoperates with the ALM REST API to run a JAVA environment independently of a com-bridge.

15. The wrapper of claim 8, wherein the wrapper is configured to operate to provide an interface for all members of the group consisting of authentication, session management, collecting domains and projects that a user can access, list collection, obtaining release-cycles and releases, mandatory fields collection for defect creation, uploading image attachment to defects and/or other ALM entities, mandatory fields collection for test creating, creating new test entities and adding the scripts to the created test entity.
